(19) United States
(12) Patent Application Publication
(10) Pub. No.: US 2010/0227788 A1
(43) Pub. Date: Sep. 9, 2010

(54) Granulate of a Sensitive Ingredient of a Washing or Cleaning Agent

(76) Inventors: Peter Schmiedel, Dusseldorf (DE); Wolfgang Von Rybinski, Dusseldorf (DE); Petra Padurschel, Erkrath (DE); Elke Scholl, Dusseldorf (DE); Stephan Gomolka, Dusseldorf (DE); Cornelius Bessler, Dusseldorf (DE); Sören Hölsken, Dusseldorf (DE); Bernhard Guckenbiehl, Koln (DE)

Correspondence Address: Henkel Corporation, 10 Finderne Avenue, Suite B, Bridgewater, NJ, 08807, US

(21) Appl. No.: 12/781,958

(22) Filed: May 18, 2010

Related U.S. Application Data
(63) Continuation of application No. PCT/EP2008/065514, filed on Nov. 14, 2008.

(30) Foreign Application Priority Data
Nov. 21, 2007 (DE) 10 2007 056 166.2

(51) Int. Cl. C11D 17/00; B05D 7/00

(52) U.S. Cl. 510/375; 510/445; 510/418; 510/403; 510/404; 427/213

(57) ABSTRACT

The present application relates to granulates of sensitive washing- or cleaning-agent ingredients. These granulates are suitable in particular for use in liquid or gelled, in particular water-containing washing or cleaning agents. The present invention further relates to methods for manufacturing such granulates, to washing and cleaning agents that contain such granulates, and to the use of suitable components for the manufacture of such granulates.

### CROSS REFERENCE TO RELATED APPLICATIONS

The present application is a continuation of International Application No. PCT/EP2008/065514 filed 14 Nov. 2008, which claims priority to German Patent Application No. 10 2007 056 166.2 filed 21 Nov. 2007.

The present invention relates to granulates of sensitive washing- or cleaning-agent ingredients. The present invention further relates to methods for manufacturing such granulates, washing and cleaning agents containing such granulates, and use of suitable components for manufacturing such granulates.

There is an extensive amount of prior art regarding formulation of sensitive washing- or cleaning-agent ingredients, particularly enzymes, in solid form. These include particles or granulate grains (granules) made up of multiple ingredients, which together comprise the formulation form of the granulate. When manufacturing washing and cleaning agents, a very wide variety of ingredients are often incorporated in the form of granulates into corresponding agents, usually solid agents. One relatively new development involves adding sensitive ingredients in the form of solid granulates to liquid washing and cleaning agents. Granulates are often described in the art for use in washing and cleaning agents, although only in the rarest cases are liquid agents explicitly addressed. Washing and cleaning agents are usually recited, with no distinction made between liquid and solid agents. This is because intensive development of liquid and gelled agents began only a few years ago, and older documents in the art were based on solid agents. Granulates developed for solid agents typically are not suitable for incorporation into liquid, particularly water-containing agents, since they are not physically stable therein and quickly disintegrate under the action of the solvent.

In order to stabilize enzyme granulates or particles having other ingredients, the art teaches covering the particles with an additional protective layer (casing, covering, coating). International Patent Publication No. WO 00/29534 A1, for example, discloses the manufacture of granulates in which various layers are applied onto an inert core or carrier. These layers can include an enzyme layer, which itself is obligatorily externally covered by one or more protective layers. Titanium dioxide, methyl cellulose (Methocel A15), polyethylene glycol (PEG 600), polyvinyl alcohol (Elvanol 51-05), and a specific nonionic surfactant (Neodol 23-6.5) are disclosed therein as examples of protective layers for the enzyme. According to the description, these granulates have high stability values and low dust coefficients. Usability in liquid and anhydrous or predominantly anhydrous agents is stated but not demonstrated, and their use in predominantly aqueous agents is not contemplated. PEG-containing coatings for enzyme-containing granulates are described in WO 96/38527 A1 and WO 97/39116 A1.

German Application DE 10 2006 018 780 discloses granulates of a sensitive washing- or cleaning-agent ingredient with enzymes being one such ingredient. The granulates described here differ from those described in the present Application in terms of features necessary for improved granulate stability in washing and cleaning agents, particularly liquid washing and cleaning agents, namely in terms of the selection and combination of the specific granulate components.

Accordingly, established methods for formulating sensitive ingredients such as enzymes for use in liquid or gelled, particularly water-containing washing or cleaning agents, are not satisfactory—either these are liquid agent requiring omission of desirable active substances in chemically very susceptible formulations, in particular bleaching agents, and the granulates are physically or chemically unstable, or the formulations can be kept stable only by means of complex and therefore expensive coating systems.

Against this background, the present invention provides an improved formulation, in particular, improved granulates wherein sensitive ingredients such as enzymes are sufficiently protected against inactivation when stored in washing and cleaning agents, particularly liquid, and very particularly water-containing washing and cleaning agents containing aggressive ingredients, in particular, bleaching ingredients. The present granulate can, advantageously, also be implemented in comparatively economical fashion.

The present invention is a granulate containing a sensitive washing- or cleaning-agent ingredient. The granulate has a core that contains

(a) the sensitive washing- or cleaning-agent ingredient,

(b) a particulate carrier material, and

(c) PEG as a binder,

as well as a casing that contains

(d) a pH-sensitive soluble polyacrylate and

(e) 1,2-propylene glycol.

In a preferred embodiment, a granulate of this kind has a core containing—

0.01 to 45 wt % of the sensitive washing- or cleaning-agent ingredient,

0.1 to 94 wt % particulate carrier material, and

1 to 20 wt % PEG.

An appropriate substance for several of these components is counted only once, so that for each granulate according to the present invention, what is involved is a mixture of components (a) and (b) and a component (c) different therefrom that encompasses the core of such a granulate. The invention correspondingly includes obtaining granulates having favorable properties by selecting favorable combinations of components (b) and (c), coordinating them advantageously with one another, and, in particular, combining them advantageously with a specific casing containing components (d) and (e). Further optional components or sensitive washing- or cleaning-agent components (a) of a different nature (e.g., enzyme preparations having different total protein contents or water contents) can be added, with an optimum for the respective quantitative ratios determined experimentally. For example, the sieve test described below for determining the disintegration index after storage of the granulate serves as a guideline for determining advantageous stability properties of a granulate.

Granulates according to the present invention are particularly physically stable in washing or cleaning agents, particularly in liquid or gelled, and very particularly in water-containing liquid or gelled washing or cleaning agents, and provide effective protection of the sensitive washing- or cleaning-agent ingredient against other compounds. For example, as demonstrated by the Examples of the present application, activities of enzyme components granulated in this fashion are maintained in liquid agents at a high level for a surprisingly long time. In particular, protection against bleaching compounds contained in such agents occurs. In addition, when used in washing and cleaning agents they exhibit good disintegration and dissolution behavior at the moment used, and enable rapid release of the contained substances while leaving behind substantially no residue on the washed material. They are also comparatively easy to manufacture. These advantageous properties are due to the specific selection and combination of granulate components. Accordingly, granulates of the present invention are not disclosed in DE 10 2006 018 780, and are notable for further improved stability versus granulates according to DE 10 2006 018 780. This is demonstrated in the Examples of the present application.

A “granulate” according to the present invention is a formulation in solid form containing multiple ingredients—i.e., in this case, a granulate core containing components (a), (b), and (c), and as a casing containing components (d) and (e)—not in the form of a powder, but in the form of discrete particles or granulate grains (granules). These are referred to in their totality as a granulate. Granulates, in particular granulate cores, generally do not have a uniform geometrical shape (i.e., their surface can be rather smooth, uneven, or even jagged). The substance is in many cases more or less porous. Granulates are preferably those whose granulate grains have a largely uniform size and/or an approximately spherical shape.

A “sensitive” washing- or cleaning-agent ingredient according to the present invention is any compound that, in the context of a washing- or cleaning-agent recipe, makes a positive and inherently desirable contribution to the washing or cleaning performance of the relevant agent, and that can be impaired in terms of its performance by the action of at least one other substance of the same recipe or also by other substances (e.g., from the air or the packaging material) having an action. A sensitive washing- or cleaning-agent ingredient (a) according to the present invention includes:
enzymes, which can be inactivated at least in part, for example, by bleaching ingredients;
scents or perfumes (for example, alcohols, aldehydes, ketones, esters, or unsaturated compounds) that can be converted, for example, by oxidizing ingredients into differently scented or unscented derivatives, for example into the corresponding carboxylic acids;
optical brighteners (for example, biphenyl derivatives having condensed double bonds, diaminostilbene derivatives, coumarin derivatives, thiazoline derivatives, etc.), which can lose the ability to fluoresce; and
bleach activators, which can react with the bleaching agent by way of a premature reaction (e.g., one taking place already during storage), so that the agent loses overall bleaching capability.

In a preferred embodiment of the invention, the granulate is therefore characterized in that the sensitive washing- or cleaning-agent ingredient is a perfume, an optical brightener, a bleach activator, an enzyme, or an enzyme mixture. In further preferred embodiment, the enzyme is a protease, amylase, cellulase, lipase, hemicellulase, pectinase, mannanase, oxidase, or perhydrolase.

These preferred sensitive washing- or cleaning-agent ingredients are discussed below in even further detail.

### Scents—

Scents are added to washing or cleaning agents in order to improve the aesthetic impression of the products and to make available to the user, in addition to washing or cleaning performance, a product that is visually and sensorially “typical and unmistakable”. It may be particularly desirable to impart to the washed material (e.g., to the textile) a specific fragrance that is retained even after the washing operation is completed.

Individual fragrance compounds (e.g., synthetic products of ester, ether, aldehyde, ketone, alcohol, and hydrocarbon types) can be used as scents. Ester fragrance compounds include benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. Ether fragrance compounds include benzylethyl ether. Aldehyde fragrance compounds include linear alkanals having 8 to 18 carbon atoms, citral, citronellal, citronellyloxyacetaldehyde, cyclamenaldehyde, hydroxycitronellal, lilial and bourgeonal. Ketone fragrance compounds include ionones, α-isomethylionone and methylcedryl ketone. Alcohol fragrance compounds include anethol, citronellol, eugenol, geraniol, linalool, phenylethyl alcohol and terpineol. Hydrocarbon fragrance compounds include terpenes such as limonene and pinene. It is also preferable to use mixtures of different fragrances that together produce an appealing scent note. Such scents can also contain natural fragrance mixtures such as those accessible from plant sources, for example, pine, citrus, jasmine, patchouli, rose, or ylang-ylang oil. Also suitable are muscatel, sage oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil. The scent content of washing or cleaning agents is usually up to 2 wt % of the entire formula. This should be taken into account when designing granulates for use in washing and cleaning agents according to the present invention.

### Optical Brighteners—

This class of ingredients when used in textile washing agents results in a positive visual impression of the clean washed material. Examples include biphenyl derivatives having condensed double bonds, diaminostilbene derivatives, coumarin derivatives, thiazoline derivatives, benzoxazole derivatives, or pyrazoline derivatives. Preferred embodiments include derivatives of diaminostilbenedisulfonic acid or its alkali metal salts. Suitable salts include 4,4′-bis(2-anilino-4-morpholino-1,3,5-triazinyl-6-amino)stilbene-2,2′-disulfonic acid or compounds of similar structure having, instead of the morpholino group, a diethanolamino group, a methylamino group, an anilino group, or a 2-methoxyethylamino group. Brighteners of the substituted diphenylstyryl type can also be present (e.g., the alkali salts of 4,4′-bis(2-sulfostyryl)diphenyl, of 4,4′-bis(4-chloro-3-sulfostyryl)diphenyl, or of 4-(4-chlorostyryl)-4′-(2-sulfostyryl)diphenyl). Mixtures of optical brighteners can also be used. Mixtures of optical brighteners comprising a distyrylbiphenyl derivative and a stilbenetriazine derivative are particularly suitable. These brightener types can be used at any mixing ratio with one another. Such brighteners are obtainable, for example, from the Ciba Company under the trade name Tinopal.

### Bleach Activators—

In order to achieve a good bleaching effect when washing at temperatures of 60° C. and below, and in particular for laundry pretreatment, washing agents can also contain bleach activators. Because of their reactivity, it is preferable to formulate these ingredients in the form of granulates according to the present invention.

Such bleach activators include compounds that, under perhydrolysis conditions, yield aliphatic peroxocarboxylic acids preferably having 1 to 10 carbon atoms, particularly 2 to 4 carbon atoms, and/or (optionally substituted) perbenzoic acids. Substances that carry O- and/or N-acyl groups having the aforesaid number of carbon atoms, and/or optionally substituted benzoyl groups, are suitable. Multiply acylated alkylenediamines, in particular tetraacetylethylendiamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or isononanoyl oxybenzenesulfonate (n- or iso-NOBS), carboxylic acid anhydrides, in particular phthalic acid anhydride, acylated polyvalent alcohols, in particular triacetin, ethylene glycol diacetate and 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular pentaacetylglucose (PAG), pentaacetylfructose, tetraacetylxylose and octaacetyllactose, as well as acetylated, optionally N-alkylated glucamine and gluconolactone, and/or N-acylated lactams, for example N-benzoylcaprolactam, are preferred. Hydrophilically substituted acyl acetates and acyl lactams are also used in preferred fashion. Combinations of conventional bleach activators can also be used.

Further bleach activators preferred for use in the context of the present Application include cationic nitriles, in particular cationic nitriles of the formula—

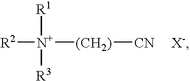

wherein R¹ is —H, —CH₃, a C₂₋₂₄ alkyl or alkenyl residue, a substituted C₂₋₂₄ alkyl or alkenyl residue having at least one substituent from the group of —Cl, —Br, —OH, —NH₂, —CN, an alkyl or alkenylaryl residue having a C₁₋₂₄ alkyl group, or a substituted alkyl or alkenylaryl residue having a C₁₋₂₄ alkyl group and at least one further substituent on the aromatic ring; R² and R³ are mutually and independently chosen from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)—H, where n=1, 2, 3, 4, 5 or 6; and X is an anion.

Particularly preferred is a cationic nitrile of the formula—

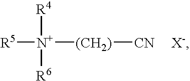

wherein R⁴, R⁵, and R⁶ are mutually independently chosen from —CH₃, —CH₂—CH₃, —CH₂—CH₂—CH₃, —CH(CH₃)—CH₃, wherein R⁴ can additionally be —H, and X is an anion; wherein preferentially R⁵═R⁶═—CH₃; and, particularly, R⁴═R⁵═R⁶═—CH₃; and compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻ are particularly preferred. Of these substances, the cationic nitrile of the formula (CH₃)₃N⁽⁺⁾CH₂—CN X⁻, wherein X⁻ is an anion chosen from chloride, bromide, iodide, hydrogensulfate, methosulfate, p-toluenesulfonate (tosylate), or xylenesulfonate, is particularly preferred.

In preferred embodiment according to the present invention, bleach catalysts can also be used in addition to or instead of the bleach activators. These substances are bleach-intensifying transition-metal salts or transition-metal complexes such as Mn, Fe, Co, Ru, or Mo salen complexes or carbonyl complexes. Mn, Fe, Co, Ru, Mo, Ti, V, and Cu complexes having nitrogen-containing tripod ligands, as well as Co, Fe, Cu, and Ru amine complexes, are also applicable as bleach catalysts.

It is particularly preferred to use complexes of manganese in oxidation states II, III, IV, or IV, which by preference contain one or more macrocyclic ligand(s) having the donor functions N, NR, PR, O, and/or S. Ligands having nitrogen donor functions are preferably used. It is particularly preferred to use bleach catalyst(s) containing 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN), and/or 2-methyl-1,4,7-triazacyclononane (Me/TACN) as macromolecular ligands. Suitable manganese complexes include [Mn^{III}₂(μ-O)₁(μ-OAc)₂(TACN)₂](C1O₄)₂, [Mn^{III}Mn^{IV}(μ-O)₂(μ-OAc)₁(TACN)₂](BPh₄)₂, [Mn^{IV}₄(μ-O)₁(μ-Oac)₂(TACN)₄](C1O₄)₄, [Mn^{III}₂(μ-O)₁(μ-OAc)₂(Me-TACN)₂](CIO₄)₂, [Mn^{III}Mn^{IV}(μ-O)₂(μ-Oac)₂(Me-TACN)₂](CIO₄)₃, [Mn^{IV}₂(μ-O)₃(Me-TACN)₂](PF₆)₂, and [Mn^{Iv}₂(μ-O)₃(Me/Me-TACN)₂](PF₆)₂(OAc═OC(O)CH₃).

Bleach activators or bleach catalysts can be present in the usual quantitative range from 0.01 to 20 wt %, preferably in quantities from 0.1 to 15 wt %, particularly 1 wt % to 10 wt %, based on total weight of the washing- or cleaning-agent composition. In certain cases, more bleach activator can also be used. This is taken into account in the formulation of granulates according to the present invention for use in washing and cleaning agents, and bleach activator content in the granulate should be increased so that such a quantity of bleach activator is available in the subsequent washing- or cleaning-agent composition.

### Enzymes—

Preferred embodiments of the present invention involve enzyme granulates. This class of ingredients provides, as a function of its respective specificity, a corresponding improvement in cleaning performance of the agent. These enzymes are typically of natural origin; however, improved variants based on the natural molecules are often available for use in washing and cleaning agents and may be preferred for use.

Sensitive washing- or cleaning-agent ingredients therefore include one or more hydrolytic enzymes and/or oxidoreductases, preferably proteases, amylases (e.g., α-amylases), cellulases, lipases, hemicellulases, in particular, pectinases, mannanases, β-glucanases, oxidases, catalases, peroxidases, laccases, perhydrolases, or mixtures thereof, among them also, preferably, oxidation-stabilized enzymes of the respective enzyme type. Particularly preferred embodiments include enzyme granulates wherein the enzyme is one or a mixture of the following enzymes: protease, amylase, cellulase, lipase, hemicellulase, pectinase, mannanase, oxidase, and perhydrolase, by preference an oxidation-stabilized enzyme of the respective enzyme type. Oxidation-stabilized enzymes are preferably those stabilized with respect to oxidation, for example, by mutagenesis, in particular point mutagenesis, and are therefore catalytically active for a longer term under oxidizing conditions than the unstabilized precursor enzyme from which it was produced.

Examples of alkaline proteases include those of the subtilisin type such as subtilisins BPN' and Carlsberg, protease PB92, subtilisins 147 and 309, the alkaline protease from Bacillus lentus, subtilisin DY, and enzymes (to be classified, however, as subtilases and no longer as subtilisins in the strict sense) thermitase, proteinase K, and proteases TW3 and TW7, as well as their further developments improved for use in washing or cleaning agents. Amylases include α-amylases from Bacillus licheniformis, B. amyloliquefaciens, or B. stearothermophilus, and their further developments improved for use in washing and cleaning agents. Also to be emphasized are the α-amylase from Bacillus sp. A 7-7 (DSM 12368) and the cyclodextrin-glucanotransferase (CGTase) from B. agaradherens (DSM 9948). Granulates according to the present invention can contain lipases or cutinases, particularly because of their triglyceride-cleaving activities, but also in order to generate peracids in situ from suitable precursors. These include, for example, the lipases obtainable originally from Humicola lanuginosa (Thermomyces lanuginosus) or further-developed lipases, particularly those having the D96L amino acid exchange. Granulates according to the present invention, especially those used for the treatment of textiles, can contain cellulases or endoglucanases (EG), depending on the application as pure enzymes, as enzyme preparations, or in the form of mixtures in which the individual components advantageously supplement one another in terms of their various performance aspects. These performance aspects include contributions to the primary washing performance and the second washing performance of the agent (antiredeposition effect or anti-gray action), and avivage (fabric effect), and even exertion of a “stonewashed” effect. Examples of cellulases able to be formulated according to the present invention include the 50-kD EG or 43-kD EG from Humicola insolens, particularly Humicola insolens DSM 1800. Also usable, for example, are the 20-kD EG from Melanocarpus and the cellulases from Bacillus sp. CBS 670.03 and CBS 669.93. In order to remove certain problem stains, granulates according to the present invention can contain enzymes referred to as hemicellulases. These include, for example, mannanases, xanthanlyases, pectinlyases pectinases), pectinesterases, pectatelyases, xyloglucanases (=xylanases), pullulanases, and β-glucanases. Particularly preferred hemicellulases are mannanases.

To enhance bleaching effect, granulates according to the present invention can also contain oxidoreductases such as oxidases, oxygenases, catalases (which react as a peroxidase at low H₂O₂ concentrations), peroxidases such as halo-, chloro-, bromo-, lignin, glucose, or manganese peroxidases, dioxygenases, or laccases (phenoloxidases, polyphenoloxidases). Granulates according to the present invention can further contain perhydrolases. Reference is made to Applications WO 98/45398 A1, WO 2005/056782 A2, and WO 2004/058961 A1 for usable examples of enzymatic perhydrolysis.

The sensitive washing- or cleaning-agent ingredient is present in the core of the granulate at a concentration of 0.01 to 45 wt %, and increasingly preferably from 0.1 to 40 wt %, 0.5 to 35 wt %, and 0.75 to 30 wt %. For an enzyme preparation, this indication is based on the dry-substance proportion of the pure enzyme. The protein concentration (i.e. including that of an enzyme to be formulated according to the present invention) can be determined with the aid of known methods, for example the BCA method (bichinchoninic acid; 2,2′-biquinolyl-4,4′-dicarboxylic acid) or the biuret method (A. G. Gornall, C. S. Bardawill and M. M. David, J. Biol. Chem., 177 (1948), pp. 751-766).

It is furthermore characteristic of the invention that the sensitive washing- or cleaning-agent ingredient is processed together with the particulate carrier material and binder into a largely uniform granulate.

A particulate carrier material according to the present invention is a material which is solid at room temperature and is powdered or particulate prior to incorporation into granulates according to the present invention. The particulate carrier material is chemically inert to the extent that, under manufacturing, processing, and storage conditions of the granulate, it does not react with any other of the ingredients of the granulate or agent to a degree that impairs the overall effectiveness of the granulates. As a result of its structure, it is able to at least partially physically bind liquids or gelled or pasty substances onto its surfaces, so that in conjunction with the present invention it can also be referred to as an adsorbent.

Particulate carrier material includes inorganic substances such as clays, silicates, or sulfates, in particular talc, silicic acid, metal oxides, in particular aluminum oxides, silicates, in particular sheet silicates, sodium aluminum silicates, bentonites and/or aluminosilicates (zeolite), and/or titanium dioxide. Also included are organic compounds, in particular organic polymers, for example polyvinyl alcohol (PVA), in particular at least partly hydrolyzed PVA. It is particularly advantageous if the particulate carrier material provides an additional benefit, for example, a builder function or a function as a disintegration adjuvant upon use of the washing or cleaning agent that contains a granulate according to the present invention. The particulate carrier material preferably involves a form of starch, derivatized starch, cellulose, or derivatized cellulose, or combinations thereof. Preferably, granulates according to the present invention comprise particulate carrier material in the form of flour, in particular wheat flour, wheat starch, corn starch, potato starch, or combinations thereof.

The particulate carrier material is present in the core of a granulate according to the present invention at a concentration of 0.1 to 94 wt % and increasingly preferably from 2 to 90 wt %, 5 to 85 wt %, 10 to 82 wt %, and 20 to 80 wt %.

As previously mentioned, it is particularly advantageous that these compounds act in supplementary fashion as disintegration adjuvants (solubility improvers), and thus improve the solubility of the granulates at the time at which the granulates are actually intended to disintegrate (i.e., at the moment of use of the agent containing them). This is because washing and cleaning agents are generally utilized in diluted form (i.e., added to an aqueous washing bath). At that moment of great dilution with water and optionally a change in pH, the casing (or coating) becomes permeable, and water diffuses into the granulates which thereupon burst and release their ingredient, so that the latter can become effective. The disintegration times of the granulate particles are thereby shortened.

These substances, which because of their action are also referred to as “bursting” agents, increase in volume upon the entry of water; on the one hand, their own volume is increased (swelling), and on the other hand the release of gases can also generate a pressure that allows the granulate particles to break down into smaller particles. Known disintegration adjuvants include carbonate/citric acid systems; other organic acids can also be used.

This disintegration process can be even further improved by the optional addition of further solubility improvers. Such further solubility improvers are present in a granulate according to the present invention in a weight proportion from 0 to 50 wt %, based on the granulate. They are preferably water-soluble inorganic salts, monosaccharides, by preference glucose, oligosaccharides, organic polymers, by preference crosslinked polyvinylpyrrolidones or crosslinked polyacrylates. The crosslinked polyvinylpyrrolidone Collidon CL (commercial product of the BASF company, Ludwigshafen) may be recited as an example of a suitable crosslinked polyvinylpyrrolidone. Further examples of organic polymers usable according to the present invention include methacrylic acid-ethyl acrylate copolymers Eudragit L 100 (Degussa company, Frankfurt/Main) and Collicoat MEA (BASF). Also suitable as further swelling solubility improvers are (optionally modified) natural substances such as cellulose and starch and derivatives thereof, alginates, or casein derivatives.

Cellulose-based disintegration agents that simultaneously function as a particulate carrier material are preferred disintegrating agents.

It is also possible to control the release of various ingredients in a washing or cleaning agent containing a granulate according to the present invention, for example, in such a way that the granulated ingredient does not go into solution until somewhat later than one or more other ingredients of the agent. It is possible in particular for granulated enzymes to take effect in time-delayed fashion with respect to a bleaching agent contained in the agent, so that a portion of the bleaching agent has already reacted in the washing bath and no longer impairs the enzyme so severely. The bleaching agent or the bleach activator can of course analogously also be caused to act in time-delayed fashion.

Polyethylene glycol (PEG) is used as a binder for granulates according to the present invention. Surprisingly and contrary to teachings in the art, it has been found that, even though it is described in the art as a not particularly advantageous binder for granulates, PEG can be used advantageously as a binder in a granulate according to the present invention, i.e., in observance of the combination possibilities with components (a), (b), (d), and (e), in particular the combination with components (a) and (b), the combination with component (b) alone, and the combination with components (d) and (e). In particular, the combination with components (d) and (e) brings about advantageous suitability of PEG as a binder. German Patent Application DE 10 2006 018 780, in particular, teaches away from this recognition. Contrary to this view, PEG is outstandingly suitable as a binder in a granulate according to the present invention (i.e., granulates according to the present invention exhibit, with PEG as a binder, advantageous properties; in particular, they are more stable in washing and cleaning agents). The particular combinations of ingredients that are used, in particular the combinations of components (b) and (c) that are used, are thus essential with regard to the granulates that are obtained. Particularly advantageous granulates are obtained when one or more starches or starch derivatives, as a particulate carrier material (b), are combined with PEG as binder (c).

PEG is present as a binder in the core of a granulate according to the present invention at a concentration from 1 to 20 wt %, preferably 2 to 15 wt %.

In a further preferred embodiment of the invention, the granulate is characterized in that the sensitive washing- or cleaning-agent ingredient (a) is an enzyme or an enzyme mixture, and the enzyme or enzyme mixture is present together with a compound that has an enzyme-stabilizing effect.

Such compounds, also referred to in the present Application as “enzyme stabilizers,” are contained as preferred additional ingredients in particular in enzyme-containing granulates. They serve, particularly during storage, as protection against damage such as, for example, inactivation, denaturing, or decomposition resulting (e.g., from physical influences, oxidation, or proteolytic cleavage). Inhibition of proteolysis is particularly preferred in the context of microbial recovery of the proteins and/or enzymes, in particular when the agents also contain proteases. Preferred granulates (or agents; see below) according to the present invention contain stabilizers for this purpose.

Reversible protease inhibitors are one group of stabilizers. Benzamidine hydrochloride, borax, boric acids, boronic acids, or salts or esters thereof are often used for this, among them principally derivatives having aromatic groups, e.g. ortho-, meta-, or para-substituted phenylboronic acids, in particular 4-formylphenylboronic acid (4-FPBA), or the respective salts or esters of the aforesaid compounds. 4-FPBA represents in this respect a particularly preferred embodiment of the invention. Peptide aldehydes, i.e., oligopeptides having a reduced C-terminus, in particular those made up of 2 to 50 monomers, are also used for this purpose. Ovomucoid and leupeptin, among others, are among the peptide-type reversible protease inhibitors. Specific reversible peptide inhibitors for the subtilisin protease, as well as fusion proteins of proteases and specific protease inhibitors are also suitable for this. Phosphates are also suitable as enzyme stabilizers. Dibutyl phosphate and diphenyl phosphate, for example, are usable in this context with particular preference. Such compounds are also reversible protease inhibitors and are therefore suitable as enzyme stabilizers. Further enzyme stabilizers are aminoalcohols such as mono-, di-, triethanol- and -propanolamine and mixtures thereof, aliphatic carboxylic acids up to C₁₂ such as, for example, succinic acid, other dicarboxylic acids, or salts of the aforesaid acids. End-capped fatty acid amide alkoxylates are also suitable for this purpose. Certain organic acids used as builders are also additionally capable of stabilizing an enzyme. Lower aliphatic alcohols, but principally polyols, for example glycerol, ethylene glycol, propylene glycol, sorbitol, or diglycerol phosphate are other frequently used enzyme stabilizers with respect to physical influences. Salts of calcium and/or magnesium are likewise used, for example calcium acetate or calcium formate. Polyamide oligomers or polymeric compounds such as lignin, water-soluble vinyl copolymers or cellulose ethers, acrylic polymers, and/or polyamides stabilize the enzyme preparation, inter alia with respect to physical influences or pH fluctuations. Polyamine-N-oxide-containing polymers act simultaneously as enzyme stabilizers and as color transfer inhibitors. Other polymeric stabilizers are the linear C₈ to C₁₈ polyoxyalkylenes. Alkyl polyglycosides can also stabilize the enzymatic components of the agent according to the present invention, and by preference are capable of additionally increasing its performance. Crosslinked nitrogen-containing compounds by preference perform a dual function as soil release agents and as enzyme stabilizers. Hydrophobic nonionic polymer stabilizes, in particular, a cellulase that may be contained. Reducing agents and antioxidants enhance the stability of the enzymes with respect to oxidative breakdown; sulfur-containing reducing agents, for example, such as sodium sulfite and reducing sugars, are common for this purpose.

It is particularly preferred to use combinations of stabilizers, for example made up of polyols, boric acid and/or borax, the combination of boric acid or borate with reducing salts and succinic acid or other dicarboxylic acids, or the combination of boric acid or borate with polyols or polyamino compounds and with reducing salts. The effect of peptide aldehyde stabilizers is favorably enhanced by combination with boric acid and/or boric acid derivatives and polyols, and even further by the additional action of divalent cations such as, for example, calcium ions. Phosphate stabilizers can also be part of a combination of stabilizers.

Fermentation medium constituents and/or accompanying substances, resulting from enzyme manufacture and not completely separated out, can additionally be present and exert a stabilizing influence on the enzyme or enzymes.

In an additionally preferred embodiment of the invention, the granulate further contains one or more compounds acting as a buffer system or pH adjusting agent. Preferably the compound acting as a buffer system or pH adjusting agent is carbonate, hydroxide, phosphate, borate, carboxylic acids or salts thereof, in particular citrate, for example. This is because granulates having these components are notable for remarkable stability and, when used in the context of a washing- or cleaning-agent recipe, for excellent solubility under application conditions.

As described above, granulates according to the present invention comprise a casing (coating or covering). The terms casing, coating, and covering are to be regarded as synonyms in the present application.

This casing provides additional protection of the ingredients, but can also fulfill other purposes, for example, delaying release, improving bulk material properties such as decreasing the dust rate, elevating stability, and/or improving visual appearance. Granulates according to the present invention comprise a casing that encompasses a pH-sensitive soluble polyacrylate and 1,2-propylene glycol.

The pH-sensitive soluble polyacrylate is preferably polyacrylate, polymethyacrylate, or methacrylic acid-ethyl acrylate copolymer. Particularly preferred pH-sensitive soluble polyacrylates are marketed under the trade name Eudragit® by the Degussa company (Frankfurt/Main). This includes the methacrylic acid-ethyl acrylate copolymer (1:1), commercial product Eudragit® L 100-55. As is evident from the Examples of the present application, such granulates according to the present invention have improved stability values. For example, in Example 1a coating was carried out using a polyacrylate of this kind (methacrylic acid-ethyl acrylate copolymer (1:1)) that yielded outstanding stability values. Also suitable for this is the commercially obtainable polymer Kollicoat MEA of the BASF company. Also usable in preferred fashion according to the present invention are combinations or mixtures of pH-sensitive soluble polyacrylates. The pH-sensitive soluble polyacrylate, or the mixtures thereof, are present from 1 to 600 wt %, and increasingly preferably from 2 to 500 wt %, from 4 to 400 wt %, from 5 to 300 wt %, from 7 to 200 wt %, and particularly preferably from 10 to 100 wt %, in the granulate, based on the granulate core.

A pH-sensitive polyacrylate has different properties, in particular a different solubility, as a function of the pH. The pH sensitivity of the polyacrylates promotes solubility of the granulates at the time at which the granulates are actually intended to disintegrate, namely at the moment of use of the agent that contains them. This is because washing and cleaning agents are usually utilized in diluted form as an aqueous washing bath. At that moment of great dilution with water, the pH changes and causes a change in the solubility of the casing. This promotes release of the ingredient or ingredients of granulates, so that the latter can become effective.

1,2-Propylene glycol serves as a plasticizer. It also contributes to stability of granulates according to the present invention. Optionally, granulates according to the present invention can contain one or more additional plasticizers. These optional plasticizers are preferably chosen from triethyl citrate, triacetin, further polyfunctional alcohols, and polyethylene glycol. For example, in Example 1a coating was produced that contained 1,2-propylene glycol as a plasticizers. This positively effected the processability and stability of the material, and thus ultimately on the advantageous properties of the resulting coated granulate. The plasticizer or the mixtures thereof are present in a quantity that corresponds to 1% to 100%, and increasingly preferably from 10% to 90%, from 20% to 80%, from 30% to 70%, and more preferably from 40% to 60% of the polyacrylate that is present. Particularly preferably, the quantity of plasticizer present is equal to 50% of the quantity of pH-sensitive soluble polyacrylate that is present, so that the ratio of plasticizer to polyacrylate is particularly preferably 1:2.

If the pH-sensitive soluble polyacrylate and/or the plasticizer involve mixtures, the percentage indications above refer to the polyacrylate mixture or the plasticizer mixture, and not separately to each individual substance.

In consideration of the indications above, a granulate according to the present invention is furthermore preferably embodied in such a way that the casing accounts for from 1.5 to 900 wt %, and increasingly preferably from 3 to 750 wt %, from 6 to 600 wt %, from 7.5 to 450 wt %, from 10.5 to 300 wt %, and particularly preferably from 15 to 150 wt % of the granulate core. A quantitative ratio of this kind between casing and granulate core has proven to be particularly advantageous for stability of the granulate. This indication refers to the completely formulated granulate. These values may also be slightly different at the time of manufacture, since granulates are usually subjected to an additional drying step even after they are coated. The water content of both the core and the coating decreases in this context, with the result that differences in the relationship among the water contents may also occur. This is the case, for example, when comparatively dilute, i.e., particularly water-containing enzyme preparations have been incorporated into the core, or when coating has occurred with an aqueous suspension of an inherently hydrophobic coating material. In the latter case, the water content of the casing that is ultimately obtained is considerably lower than that of the core.

In a preferred embodiment of the invention, the granulate has a casing having an average layer thickness of at least 10 μm. The layer thickness is, with increasing preference, at least 20 μm, 30 μm, 40 μm, 50 μm, and 60 μm, but it can also be equal to 70 μm, 80 μm, 90 μm, or 100 μm. A sufficient average minimum layer thickness is necessary and advantageous for stability of the granulate.

Granulates according to the present invention can have more than one casing. A further preferred embodiment of the invention is a granulate having a second casing. It is understood that multiple casings differing in terms of their composition can be applied onto the core material. Also understood is the situation wherein a casing comprises different layers that can differ with regard to compositions. The differentiation of casings can thus be made, for example, on the basis of their composition and/or on the basis of their average spacing from the granulate core and/or on the basis of their sequential application onto the granulate. The layer thicknesses and quantitative indications described above refer in this context to each casing that is present, i.e. in the case in which two or more casing layers are present, each layer can exhibit the indicated layer thickness and can be present in the quantities indicated.

In a preferred embodiment of the invention, the second casing of the granulate contains more than 10 wt % PEG. A distinction is to be made here between the PEG concentration of the granulate core and the PEG concentration of the casing.

Further optional ingredients of the granulate coating will be described below. No distinction is made here between different casings; in other words, each casing can contain these ingredients.

A casing can further contain one or more fillers chosen from inorganic particles, preferably silicate, silicic acid, titanium dioxide or aluminum oxide, particularly preferably talc. Such fillers can influence the overall plasticity of the relevant coating and/or of the particles that are obtained, to improve their resistance to diffusion, or to regulate the bulk density of the particles. Each casing of the granulate, i.e. including a second as well as any further casing, can furthermore contain plasticizers that are selected from the group of: triethyl citrate, triacetin, polyfunctional alcohol, in particular 1,2-propanediol, and polyethylene glycol. The casing of a granulate according to the present invention can moreover additionally contain color pigments, by preference titanium dioxide. Color pigments serve, according to the present invention, to improve the visual appearance of the granulates and can also have a generally positive effect on the plasticity of the respective material. The casing of a granulate according to the present invention can also additionally contain one or more compounds acting as an antioxidant. In conjunction with the present invention, for which the underlying object is in particular to protect ingredients from bleaching agents, i.e. from oxidation, it is advisable and encompassed by the present Application to supplement this protective function of the granulates with an additional protection exerted via the coating. It therefore advantageously contains antioxidants. Antioxidants are known per se to one skilled in the art. It is common practice, for example, to increase the stability of enzymes with respect to oxidizing decomposition by means of sulfur-containing reducing agents, sodium sulfite, and/or reducing sugars. Further compounds to be recited as suitable at this juncture are, for example, ascorbic acid, tocopherol, gallates, thiosulfates, substituted phenols, hydroquinones, pyrocatechols, and aromatic amines, as well as organic sulfides, polysulfides, dithiocarbamates, phosphites, phosphonates, and vitamin E.

Granulates according to the present invention preferably have an average particle diameter from 100 to 4000 μm, by preference 200 to 2500 μm, particularly preferably 400 to 3000 μm. These size ranges have proven to be advantageous for achieving rapid disintegration and release of the ingredients at the moment when the agent in question is used, and moreover impart a particular aesthetic impression to the product. It is additionally visually more appealing, and moreover advantageous in terms of handling and in order to achieve a consistent action profile, to provide the granulate particles with a size distribution that is as uniform as possible, in which context a certain variability must be taken into account depending on the manufacturing method. The size of the particles can be regulated by way of variations, known to one skilled in the art, in the manufacturing methods utilized for manufacture of the particles. For example, those granulates obtainable by extrusion in which 90% of all particles fall within a range of +/−20% of the average size are preferred. This can be controlled by way of the nozzle plate. In the case of granulates obtained by way of fluid bed methods, those in which 90% of all particles fall within a range of +/−50% of the average size are preferred. As is also ultimately the case for extrudates, this can be ensured by sieving.

### Disintegration Index as an Indication of Stability of Granulates—

“Disintegration” according to the present invention is the macroscopically observable breakdown of the granulate particles. This does not mean a possible minor swelling of the granulate particles in a highly water-containing environment, that does not substantially impair the activity of the granulated ingredients, or the dissolution of isolated smaller particles, which can certainly be observed in the case of granulates according to the present invention. It is likewise consistent with the invention if slight abrasion occurs, which if applicable may be observed as suspended material in a liquid or gelled preparation containing the particles according to the present invention, and/or results in slight turbidity. What is critical is that after the storage period in question, the granulate can still be considered discrete and that with the naked eye it can be distinguished, in particular from the sodium sulfate/sodium citrate solution serving according to the present invention as a reference, as a separate solid, particulate phase.

“Storage” is to be understood for purposes of the test described below as holding the mixture in question at a constant 23° C. for at least 24 hours, and increasingly preferably for at least 30 hours, 36 hours, 42 hours, 48 hours, 3 days, 4 days, 5 days, 6 days, and most preferably for at least 7 days. Storage occurs in an unevacuated vessel externally sealed in airtight fashion, such that the volume of the air phase does not exceed that of the liquid being measured. Storage occurs in an aqueous buffer system made up of 16% sodium sulfate and 3% sodium citrate, pH 5.0+/−0.1 (reference).

For an experimental investigation as to whether, according to the present invention, no disintegration occurs after this period of time (after storage), the liquid containing the granulates is subjected to a sieve test. For this purpose it is poured, quantitatively and without application of any pressure or vacuum, through a sieve that has a mesh opening smaller than the granulate, so that the granulate is retained by the sieve. The mesh opening of the sieve can be, for example, 280 μm. The sieve can be rinsed with a sodium sulfate/sodium citrate solution of the same composition, and lastly rinsed again with distilled water. Example 5 describes performance of this verification, in which shaking was additionally performed at low speed during incubation; this is not absolutely necessary according to the present invention. Non-disintegration according to the present invention can be referred to if, after drying of the sieve remainder, more than 50 wt % of the originally weighed particle mass (before being stirred into the solution) remains behind on the sieve. Increasingly preferably more than 60, 70, 80, 90, and very particularly preferably more than 95% of the originally weighed particle mass remains behind on the sieve.

The disintegration index is defined, for the particles in question, as the quotient of the particle mass remaining behind on the sieve (remainder) and the originally weighed particle mass, and is indicated as a weight percentage remainder, the remainder being ascertained after storage of the particles as described above. The fewer particles that disintegrate during the storage period and are not retained on the sieve, the higher the numerical value of the disintegration index. Non-disintegration according to the present invention exists if the disintegration index is equal to at least 50%. Increasingly preferably the disintegration index is equal to 60, 70, 80, 90, and very particularly preferably more than 95%.

The solution according to the present invention can be transferred to all sensitive ingredients (component (a)) indicated in conjunction with the present invention. This is because they are all fundamentally jeopardized similarly (in particular in terms of oxidation), and in principle are protected in the same way according to the present invention.

In a particular embodiment of the enzyme granulates, the degree of disintegration can be based not on largely maintaining the mass of the particles, but on maintaining enzyme activity. Depending on the enzyme that is processed, enzyme activity can be determined using methods known per se. For example, it has been shown experimentally that in the case of the granulates described in the Examples as being in accordance with the invention, not only did most of the originally weighed particle mass (prior to stirring into the solution) remain behind on the sieve, but also a greater part of the enzyme activity. This refers to more than 50% and increasingly preferably more than 60, 70, 80, 90, and very particularly preferably more than 95%. Granulates of the existing art, on the other hand, which were of a different structural configuration, exhibited considerably poorer values. Among these were those having an inert core (made of MgSO₄) onto which an enzyme-containing layer was applied. In the sieve test indicated above, these particles exhibited apparent physical stability to quite a large extent (although not more than 50% according to the sieve test indicated above), but the enzyme-containing layer had been washed off so quickly that these granulates were not suitable for the purpose envisaged here according to the present invention.

### Methods for Manufacturing Granulates—

A further subject of the present invention includes methods for manufacturing granulates according to the present invention. Manufacturing methods for granulates are known to one skilled in the art. Chapter 6 (“Production of powdered detergents”) of the article “Laundry detergents” in Ullmann's Encyclopedia of Industrial Chemistry (Wiley, VCH, 2005), for example, describes a variety of methods established in the existing art for preparing various chemical compounds, in particular for use in washing and cleaning agents. Also listed among them is the extrusion method, with which comparatively high densities and low-dust products can be achieved. According to the present invention, a manufacturing method that encompasses extrusion of the core materials as a method step is particularly advantageous, since thermal stress on the enzyme preparation can thereby be kept low. In principle, all known methods for extrusion are applicable according to the present invention. An extrusion temperature below 60° C. and an extrusion pressure in the range from 30 to 130 bar, in particular in the range from 50 to 90 bar, are advantageous according to the present invention. The material leaving the extruder is passed through an orifice plate having a downstream cutoff knife, and thereby comminuted into particles of a defined size. The diameter of the orifices in the orifice plate is usefully 0.7 to 1.2 mm, by preference 0.8 to 1.0 mm. It may also be advantageous for the substance emerging from the nozzle plate of the extruder not to be cut off immediately at the nozzle head, but instead to interpose a cooling section through which the material passes before granulation is accomplished in a cutting apparatus. The particles obtained can then be dried, rounded (spheronized), and/or coated. Drying is by preference accomplished with the use of a fluid bed drying system at inflow air temperatures from by preference 35° C. to 70° C., and in particular at a product temperature of not more than 60° C., to the desired residual moisture level of, for example, 2 wt % to 10 wt %, in particular 3 wt % to 8 wt %, based on the entire granulate.

According to the present invention, it is particularly advantageous in the context of granulate manufacture if a liquid enzyme preparation, for example, coming directly from fermentative production, is incorporated in an aqueous solution into the paste for manufacture of the granulates. In a preferred embodiment of the invention, the PEG binder (component (c)) is therefore processed simultaneously with the sensitive washing- or cleaning-agent ingredient, in particular an enzyme, by preference in the form of a previous mixture of those two components. It has been found, surprisingly, that simultaneous processing of these components causes the resulting granulates to be particularly stable. Liquid enzyme preparations having an enzyme protein content from 0.1 to 50%, by preference 5 to 40%, particularly preferably 10 to 35%, are suitable, for example, for manufacturing the granulates.

Methods for encasing or coating granulates are likewise known in the existing art. For example, the coating materials, in particular those having a waxy structure and/or consistency (i.e. having melting points above room temperature) can be applied in the form of a melt. Organic coating materials in particular can be applied as a solution dissolved in an organic solvent. All these methods are possible implementations of the present invention. Those according to which the coating materials are applied in the form of an aqueous solution or suspension, and any excess water is then evaporated, are, however, preferred. This is because the risk of denaturing sensitive ingredients, in particular enzymes, contained in the granulate particles, at elevated temperature or upon contact with the relevant solvents, is thereby decreased. Perfumes that are contained might also be dissolved out of the particles again with organic solvents. Coating with the aid of the water as a solvent is also preferred in terms of environmental protection.

In a preferred embodiment of the invention, the method is characterized in that the coating material is sprayed from an aqueous solution/suspension, in a fluid bed apparatus, onto the particles to be coated. In this context the granulate particles, by preference enzyme particles, are made available in a hot-air stream and the coating material is sprayed on through a top sprayer. This occurs preferably under drying conditions (i.e., 40 to 45° C.) so that the product is at approximately 35 to 38° C. and remains dry.

In a further preferred embodiment of the invention, the method is characterized in that the total mass of the casing material that forms the outer casing amounts to 1.5 to 900 wt %, and increasingly preferably from 3 to 750 wt %, from 6 to 600 wt %, from 7.5 to 450 wt %, from 10.5 to 300 wt %, and particularly preferably from 15 to 150 wt %, of the granulate core. As already described above for the granulates, a quantitative ratio of this kind between the casing and granulate core, i.e. uncoated granulate, has proven particularly advantageous for the stability of the granulate that is obtained.

In a very particularly preferred embodiment of the invention, the method is characterized in that a neutralization of the polyacrylate with ammonia occurs. This has proven particularly advantageous because the ammonia presumably evaporates in the context of the coating process, and the polymer is thus returned back to its insoluble acid form. Very particularly considerable improvements in the stability of the granulate result therefrom.

A further subject of the invention is constituted by washing or cleaning agents containing a granulate according to the present invention as described above. According to the present invention, solid, liquid, or gelled washing and cleaning agents that contain sensitive ingredients, in particular enzymes, are made available, having good protection against other (in particular, bleaching) ingredients. The formulation form as a granulate according to the present invention is largely physically stable in order to perform its protective function. On the other hand, it exhibits good release behavior upon use, i.e. at the time of dilution by the aqueous washing bath, so that the sensitive ingredients, in particular enzymes, are quickly ready in active form and leave practically nothing behind on the washed material. The washing or cleaning agent is preferably predominantly liquid, gelled, or pasty, and by preference water-containing. With further preference, a washing or cleaning agent of this kind is characterized in that it has a water content of, increasingly preferably, 5 to 95, 10 to 90, 20 to 80, 30 to 70, 40 to 60, 45 to 55 wt %, and very particularly preferably of 50 wt %.

In a further preferred embodiment of the invention, the washing or cleaning agent has a density from 1.00 to 1.50 g/ml, by preference from 1.02 to 1.30 g/ml, particularly preferably from 1.05 to 1.15 g/ml. A washing or cleaning agent according to the present invention can furthermore contain an inorganic salt, by preference a sulfate, particularly preferably sodium sulfate, this being present at a concentration from 3 to 30 wt %, by preference 5 to 20 wt %, particularly preferably 7 to 10 wt %, in the liquid, gelled, or pasty phase. This is because regulation of the density on the one hand, and/or the water and/or electrolyte content on the other hand, of the washing or cleaning agent allows it to be adapted in terms of its physicochemical properties to those of the granulate particle. Floating of the particles in a predominantly liquid, gelled, or pasty agent of this kind is advantageous, desirable in many respects, and achievable in this fashion. The optimum in terms of the density, consistency, and dissolution behavior of the granulate particles on the one hand, and the water and/or electrolyte content and density of the agents on the other hand, must be ascertained experimentally in the individual case. Particular care must be taken in this context that the particles do not prematurely disintegrate.

Granulates according to the present invention are of course also advantageously usable in solid washing and cleaning agents.

In the case of enzyme granulates, agents equipped with granulates according to the present invention by preference contain enzymes in total quantities from 1×10⁻⁸ to 5 percent by weight, based on active protein. This must be correspondingly taken into consideration when designing granulates according to the present invention that are provided for use in washing and cleaning agents.

A further preferred embodiment of the invention refers to washing or cleaning agents further containing a bleaching agent that is selected from the group of: enzymatic bleaching system, inorganic bleaching system, organic bleaching system, or a mixture thereof.

Bleaching agents for use in washing and cleaning agents are known per se. Bleaching agents and systems that are advantageous according to the present invention will therefore be described in further detail below. Among the compounds that serve as bleaching agents and yield H₂O₂ in water, percarbonate and perborate, in particular sodium percarbonate, sodium perborate tetrahydrate, and sodium perborate monohydrate, have particular significance. Bleaching agents from the group of the organic bleaching agents can also be used. Typical organic bleaching agents are the diacyl peroxides such as, for example, dibenzoyl peroxide. Further typical organic bleaching agents are the peroxy acids.

The bleaching agents are preferably utilized in combination with bleach activators, in particular with bleach activators as described above. This advantageously brings about improved bleach performance. Washing or cleaning agents that contain 1 to 35 wt %, by preference 2.5 to 30 wt %, particularly preferably 3.5 to 20 wt %, and in particular 5 to 15 wt % bleaching agent, by preference sodium percarbonate, are particularly preferred according to the present invention.

In particularly preferred embodiments of the invention, the washing or cleaning agent contains a bleaching agents that involves—
(i) H₂O₂ or an H₂O₂-forming system, in particular percarbonate,
(ii) H₂O₂ or an H₂O₂-forming system, respectively in combination with a peroxycarboxylic acid precursor, in particular tetraacetylethylenediamine (TAED),
(iii) a preformed peroxycarboxylic acid, in particular 1,12-diperdodecanedioic acid (DPDDA), phthalimidoperoxyhexanoic acid (PAP), particularly preferably PAP, or
(iv) a combination of (i) and/or (ii) and/or (iii).

Further bleaching agents usable according to the present invention are represented by enzymatic and chemical/enzymatic bleaching systems. Here a suitable substrate is converted by a corresponding enzyme so that hydrogen peroxide is produced. This can then be activated enzymatically or chemically. Conversely, chemically released hydrogen peroxide can also be converted by an enzymatic system into an activated form. Washing and cleaning agents such that the sensitive ingredient is an oxidative enzyme are thus a preferred embodiment of this aspect of the invention. In this fashion, on the one hand the oxidative enzyme is protected from compounds acting on it, for example from the highly concentrated surfactants of a liquid washing-agent formulation. On the other hand, the enzyme and substrate can thereby be largely separated from one another, so that a reaction between the two occurs only at the moment of use, i.e. as the granulate particles burst when greatly diluted with water. In this fashion, the substrate is not consumed prematurely and is available practically entirely for the desired use.

A combined enzymatic bleaching system, encompassing an oxidase and a perhydrolase, is described e.g. by the Application WO 2005/124012.

In accordance with the statements above, the present invention is also implemented by suitable utilization capabilities for formulating sensitive washing- or cleaning-agent ingredients in the form of granulates in comparatively stable fashion. A further subject of the invention is thus represented by use of the components—

(a) a sensitive washing- or cleaning-agent ingredient,

(b) a particulate carrier material,

(c) PEG as a binder,

(d) a pH-sensitive soluble polyacrylate, and

(e) 1,2-propylene glycol, to manufacture a coated granulate of said sensitive washing- or cleaning-agent ingredient. This use is preferably characterized in that the core of the granulate contains—

0.01 to 45 wt % of the sensitive washing- or cleaning-agent ingredient,

0.1 to 94 wt % of the particulate carrier material, and

1 to 20 wt % PEG.

Further embodiments of this aspect of the invention are evident correspondingly from what has hitherto been presented, to which reference is herewith expressly made; from the granulates according to the present invention; from their manufacturing methods; and from the washing and cleaning agents that contain them.

The Examples below further explain the invention but do not limit it thereto.

### EXAMPLES

### Example 1

### Manufacture of Enzyme Granulates According to the Present Invention

A core granulate according to the present invention of the following composition was manufactured by extrusion—

| | |
|---|---|
| 5% | pregelatinized wheat starch |
| 20% | aqueous enzyme preparation (Everlase ®, Novozymes) |
| 30% | corn starch |
| 6% | PEG 4000 |
| 4% | sucrose |
| 10% | Arbocel ® (J. Rettenmaier & Söhne GmbH + Co. KG, |
| | Rosenberg) |
| 20% | wheat flour |
| 5% | water |

The extrudate was extruded through a 1.5 mm nozzle, cut off while hot, rounded, and dried.

After drying of the core granulate, it still possesses approx. 6% residual moisture. The following ingredient proportions are therefore obtained for the granulate according to the present invention—

| | |
|---|---|
| 6% | pregelatinized wheat starch |
| 7% | aqueous enzyme preparation (Everlase ®, Novozymes) |
| 35% | corn starch |
| 8% | PEG 4000 |
| 6% | sucrose |
| 13% | Arbocel ® (J. Rettenmaier & Söhne GmbH + Co. KG, |
| | Rosenberg) |
| 24% | wheat |

The core granulate was then encased in a fluidized bed unit with a casing made up of—

16.7% TiO₂

16.7% PEG 12000

water to 100%

and 10% of this coating solution was sprayed onto the core granulate.

The material was then covered again in a fluidized bed unit with a further casing layer. The spray solution was made up of—

15% Eudragit L 100, of Degussa

7.5% 1,2-propanediol

4.9% of a 33% ammonia solution

200% of this solution (based on core material) was sprayed on. The result thereof was an average casing layer thickness of approximately 70 μM.

### Example 2

### Manufacture of a Washing Agent According to the Present Invention

A water-containing baseline liquid washing-agent recipe having a pH of 5.0+/1 0.2 was used for the comparison tests. 98 parts by weight of this liquid washing agent were mixed with 2 parts by weight of the enzyme granulate according to the present invention from Example 1. The resulting washing agent according to the present invention is referred to hereinafter as E1. The practical utilization concentration of a washing agent of this kind in a washing bath is approximately 5 g/l.

### Example 3

### Manufacturing Comparison Formulations from the Art

For the comparison recipes, the enzymes were incorporated in various formulations into baseline liquid washing-agent recipes in accordance with Example 2. In the present case, the Everlase® protease was used in formulations known in the art. The following compositions were Produced—
V1: 2% Everlase 12 T (granulate)
V2: 2% Everlase 16 L (liquid enzyme)
V3: 2% of a coated granulate according to Example 4 (pattern E4c) of DE 10 2006 018 780, manufactured as follows—

For this comparison granulate V3, partially hydrolyzed PVA (commercial name Mowiol® 4-88; manufacturer Clariant Co., Frankfurt/M., Germany) was used as a carrier material component. 600 g was placed in the fluid bed unit of the Fieler-Aeromatic company (Bubendorf, Switzerland) and sprayed at 60° C. with a mixture of 500 ml protease solution (Everlase® 16 L, Novozymes A/S) and with 500 ml of a 10% solution of a polyacrylate (methacrylic acid-ethyl acrylate copolymer (1:1); commercial product Eudragit® L 100-55 of the Rohm company, Darmstadt, Germany; now Degussa, Frankfurt/M.), that had previously been adjusted with concentrated caustic soda solution to pH 7.2. The granulate thereby obtained was sieved to a particle size of 0.6 mm to 1.2 mm.

In addition to the protease component (approx. 5 wt %) and water (approx. 10 wt %), this granulate therefore contained 78 wt % of the particulate carrier material (b) and 7 wt % of the polyacrylate binder.

900 g of this granulate was sprayed at 60° C. in the fluid bed unit with 1800 ml of a 10% solution of Eudragit® L 100-55 (see above) that had previously been adjusted with concentrated caustic soda to pH 7.2 and to which 5% triethyl citrate (based on the polymer content) had been added as a plasticizer. Encased enzyme granulates were thereby obtained and were sieved through a 2000-μm sieve. The granulate therefore contained a casing that accounted for approx. 21% of the mass of the granulate core. The density of the encased granulates was approx. 1.29 g/ml in each case.

### Example 4

### Comparison of Recipe According to the Present Invention with Comparison Recipes

Recipes E1 and V1, V2, and V3 were stored at the temperatures indicated in the table in the recipe from Example 2. After time periods of 0, 1, 2, 4, and 8 weeks, enzyme activity was determined using a Continuous Flow Analysis apparatus from the Skalar company (Erkelenz, Germany). The method is based on casein cleavage, staining of the hydrolysis product with trinitrobenzenesulfonic acid, and photometric determination of the latter. The table below indicates the percentage residual activity of the protease based on initial activity directly after production of the samples and after the respective storage times and temperatures:

| Sample/T | Initial value | 1 week | 2 weeks | 4 weeks | 8 weeks |
|---|---|---|---|---|---|
| V1/25° C. | 100% | 45 | 30 | 15 | 0 |
| V2/25° C. | 100% | 0 | 0 | 0 | 0 |
| V3/25° C. | 100% | 95 | 88 | 68 | 45 |
| E1/30° C. | 100% | n.d. | 99 | 92 | 52 |

From the above it is seen that the liquid enzyme in V2 is completely inactivated in a very short time, probably due to the PAP bleaching agent. The commercially available enzyme granulate V1 exhibits greater but by no means satisfactory stability. With the formulation E1 according to the present invention, convincing storage stability data are obtained even in comparison with V3, despite a higher storage temperature.

In addition, the enzyme granulate according to the present invention in this formula is substantially more easily soluble, when diluted to application concentration with water (5 g/l), than the granulate V3. Here 90% has disintegrated after 5 minutes, whereas with V3 it is only after 15 minutes that no further coarse, flaky deposits can be observed.

### Example 5

### Disintegration Test of Enzyme Granulates

The following disintegration test was carried out with the granulates from Example 1:

1 g of each of the enzyme preparations was weighed out and placed into a 50 ml glass flask to which 30 ml of a 16% sodium sulfite/3% sodium citrate solution, which had been adjusted with 10% sulfuric acid to pH 5.0, was added. This mixture was agitated for 24 hours at 23° C. on a laboratory shaker (Certomat® U, Braun Company, Melsungen) at 100 revolutions per minute. The dispersion processed in this fashion was then filtered through an E-D Schnellsieb fast sieve, 0.28 mm mesh opening, with no application of pressure, and rinsed with 50 ml distilled water.

The sieve was dried for 48 hours at 35° C., and the granulate that remained in the sieve was weighed out and referred to the initial value. Two determinations were carried out in each case.

Granulates according to the present invention exhibited substantially no disintegration, i.e. they presented disintegration index values that were well above 50%. This means that the greater part of the granulates does not disintegrate in the test solution upon storage (and even when shaken).

1. Granulate comprising a sensitive washing- or cleaning-agent ingredient having a core comprising:
(a) the sensitive washing- or cleaning-agent ingredient,
(b) a particulate carrier material, and
(c) PEG as a binder,
and a casing comprising
(d) a pH-sensitive soluble polyacrylate and
(e) 1,2-propylene glycol.

2. Granulate according to claim 1, wherein the core of the granulate comprises:
0.01 to 45 wt % of the sensitive washing- or cleaning-agent ingredient,
0.1 to 94 wt % particulate carrier material, and
1 to 20 wt % PEG,
all based on total weight of the granulate.

3. Granulate according to claim 1, wherein the sensitive washing- or cleaning-agent ingredient is an enzyme or an enzyme mixture, and the enzyme or the enzyme mixture is present together with a compound having an enzyme-stabilizing effect.

4. Granulate according to claim 1 further comprising one or more compounds acting as a buffer system or pH adjusting agent.

5. Granulate according to claim 1, wherein the casing has an average layer thickness of at least 10 μm.

6. Granulate according to claim 1 further comprising a second casing having more than 10 wt % PEG.

7. Granulate according to claim 1 further comprising:
at least one casing having one or more inorganic particulate fillers, and/or
at least one casing having one or more plasticizers chosen from triethyl citrate, triacetin, polyfunctional alcohol, and polyethylene glycol, and/or
at least one casing having a color pigment, and/or
at least one casing having one or more antioxidants.

8. Granulate according to claim 1 having an average particle diameter from 100 to 4,000 μm.

9. Method for manufacturing a granulate according to claim 1 comprising:
extruding the core materials, and/or
simultaneously processing the PEG binder (component (c)) with the sensitive washing- or cleaning-agent ingredient, and/or
spraying the casing material from an aqueous solution/suspension into a fluid bed apparatus and onto the particles to be coated.

10. Method according to claim 9, wherein the total mass of casing material that forms the outer casing amounts to 1.5 to 900 wt % of the granulate core.

11. Method according to claims 9, further comprising neutralizing the polyacrylate with ammonia.

12. Washing or cleaning agent comprising a granulate according to claim 1.

13. Washing or cleaning agent according to claim 12 wherein the agent is liquid, gelled, or pasty.

14. Washing or cleaning agent according to claim 12 wherein the agent has a water content of 5 to 95 wt % and/or a density of from 1.00 to 1.50 g/ml.

15. Washing or cleaning agent according to claim 12 further comprising a bleaching agent chosen from enzymatic bleaching system, inorganic bleaching system, organic bleaching system, or a mixture thereof.

16. Washing or cleaning agent according to claim 15 wherein the bleaching agent comprises:
(i) H₂O₂ or an H₂O₂-forming system,
(ii) H₂O₂ or an H₂O₂-forming system in combination with a peroxycarboxylic acid precursor,
(iii) preformed peroxycarboxylic acid, or
(iv) a combination of (i) and/or (ii) and/or (iii).
